(19) United States
(12) Patent Application Publication
(10) Pub. No.: US 2012/0100856 A1
(43) Pub. Date: Apr. 26, 2012

(54) MOBILE COMMUNICATION SYSTEM, TERMINAL DEVICE, AND BASE STATION

(75) Inventors: Chie Ishida, Kanagawa (JP); Takahisa Aoyama, Kanagawa (JP); Hong Tat Toh, Singapore (SG); Hong Cheng, Singapore (SG); Tien Ming Benjamin Koh, Singapore (SG)

(73) Assignee: PANASONIC CORPORATION, Osaka (JP)

(21) Appl. No.: 13/344,882

(22) Filed: Jan. 6, 2012

Related U.S. Application Data
(63) Continuation of application No. PCT/JP2010/004432, filed on Jul. 7, 2010.

(30) Foreign Application Priority Data
Jul. 10, 2009 (JP) 2009-163883

(51) Int. Cl. H04W 36/00

(52) U.S. Cl. 455/436

(57) ABSTRACT

In a mobile communication system, a handover of a terminal device (MT) from a macrocell base station (eNB) to a small cell base station (HeNB) is controlled via a host device (MME or HeNB-GW). Physical cell ID deployment map information (PCI deployment map information), which includes at least information (PCI/CGI map information) indicating the correspondences between physical cell IDs and unique cell IDs of CSG cells for which access is granted, is generated in the host device (MME or HeNB-GW). When the terminal device measures the reception quality for surrounding CSG cells for handover control to any of the CSG cells, the terminal device uses the PCI deployment map information to generate a measurement result report. Thus, a service interruption caused by handover control to an inaccessible small cell can be avoided, and the wait time for handover control can be reduced.

### TECHNICAL FIELD

The present invention relates to a mobile communication system in which a handover of a terminal device from a macrocell base station to a small cell base station is controlled via a host device.

### BACKGROUND ART

In a mobile communication system (e.g., based on 3GPP LTE (Long-Term Evolution), a mobile terminal (MT) needs to address handovers from one cell to another. Such handovers include a handover between macrocells, a handover between CSG cells, and a handover between a macrocell and a CSG cell. In a handover from a macrocell to a CSG cell, a base station (eNB) and a home base station (HeNB) do not directly connect with each other, and only a handover (S1 handover) via a core network (also called a mobility management entity (MME)) is possible. In current network configurations, access control for a handover from a macrocell to a CSG cell (also called an inbound handover) is performed by the mobility management entity (MME).

When a handover between macrocells is performed, a report (a measurement result report of reception quality) including a physical cell ID (PCI) of a handover destination cell is transmitted from a mobile terminal to a network. The network handles the handover according to the report (identifies the handover destination cell from the PCI). However, base stations of CSG cells are provided in places such as homes and shops, and therefore it is expected that more base stations of CSG cells exist than those of macrocells. Consequently, adjacent CSG cells possibly have the same PCI. In such a case, transmitting the report (including only the PCI) from the mobile terminal to the network only once is insufficient for the MME to perform access control. A second measurement result report including information such as a unique cell ID (a CGI) that allows uniquely identifying the CSG cell is required, leading to a long wait time for handover control.

A possible approach to eliminating the need of the mobile terminal generating the second measurement result report is the use of fingerprint information. In this approach, the mobile terminal has to store, as history information (fingerprint information) about the mobile terminal, information about cells on which the mobile terminal previously camped (i.e., information including position information (GPS information) and identification information (such as a CGI or PCI) about cells to which the mobile terminal is granted access). With the history information, the mobile terminal can determine whether a cell detected as a handover destination candidate is a cell for which access is granted. If it is determined that access to the detected cell is granted, the mobile terminal can include the CGI information corresponding to the PCI into the first measurement result report (which usually includes only the PCI) and transmit the report to the eNB. The eNB can then identify the handover destination cell without receiving the second measurement result report from the mobile terminal.

However, the above approach of using the fingerprint information has some limitations. By way of example, the mobile terminal is not necessarily able to use accurate history information: the history information may become outdated, for example. The mobile terminal is not always able to use position information: GPS information becomes inaccurate particularly in indoor or underground use, for example. In consideration of these limitations, the approach of using the fingerprint information may let the mobile terminal make an incorrect cell determination due to incorrect cell position information. If a handover is controlled based on the incorrect cell determination (e.g., if a handover is incorrectly controlled to a cell for which access is actually not granted), the handover process may fail and result in an interruption of a service that the mobile terminal has been receiving.

To solve the above problems, improvements may be made on the approach of using the fingerprint information. For example, the approach may be improved to enable the mobile communication to use more accurate position information. However, as mentioned above, the terminal device may not always be able to use the position information.

The use of other techniques may be possible. For example, the mobile terminal may always be required to report the CGI information in the first measurement result report. However, since it takes long time to obtain the CGI (compared to the PCI), transmitting the first report is delayed. In addition, in order to know the CGI of the handover destination cell (also called a target cell), the mobile terminal needs to access announcement information (SIB1) about the cell. This increases the delay time for the mobile terminal to transmit the measurement result report.

### CITATION LIST

### Non Patent Literature

Non Patent Literature 1: 3GPP TS23.401 SAE
Non Patent Literature 2: 3GPP TS36.331 RRC protocol
Non Patent Literature 3: 3GPP TS36.304 IDLE mode
Non Patent Literature 4: 3GPP TS24.301 NAS

### SUMMARY OF INVENTION

### Technical Problem

The present invention has been made against the background described above. An object of the present invention consists in providing a mobile communication system that enables avoiding the occurrence of a service interruption and reducing the wait time for handover control.

### Solution To Problem

An aspect of the present invention is a mobile communication system in which a handover of a terminal device from a macrocell base station to a small cell base station is controlled via a host device. The host device includes: cell position information reception means for receiving cell position information including identification information about small cells around the terminal device from the macrocell base station or a small cell base station on which the terminal device is camping; small cell identification means for, according to the received cell position information, identifying small cells which are around the terminal device and to which the terminal device is granted access, by using the identification information about the small cells; local map information acquisition means for acquiring local map information from small cell base stations for the identified small cells, the local map information including physical cell IDs of the identified small cells and physical cell IDs of small cells around the identified small cells; and deployment map information generation means for, according to the acquired local map information, generating physical cell ID deployment map information including at least information indicating correspondences between the physical cell IDs and unique cell IDs of the small cells for which access is granted. The terminal device includes: deployment map information reception means for receiving the physical cell ID deployment map information generated by the host device from the host device; and measurement result report generation means for generating a measurement result report of reception quality by using the physical cell ID deployment map information when a request to measure the reception quality for small cells around the terminal device for controlling a handover to any of the small cells is received via the host device.

In the present invention, the physical cell ID deployment map information including at least the information indicating the correspondences between the physical cell IDs and the unique cell IDs is used to generate the measurement result report. Therefore, even if two or more small cells having the same physical ID exist within a macrocell, an accessible small cell can be identified from the unique cell ID. This enables avoiding a service interruption caused by performing handover control to an inaccessible small cell and ending in a handover failure. Also, the need of the conventionally-required second measurement result report is eliminated, which enables a reduction in the wait time for handover control.

As will be described below, the present invention has other aspects. Therefore the above summary of the invention is intended to provide only a part of aspects of the present invention and not to limit the scope of the invention described and claimed herein.

### BRIEF DESCRIPTION OF DRAWINGS

FIG. 1 is an illustrative diagram of a configuration of a mobile communication system in a first embodiment of the present invention.

FIG. 2 is a block diagram showing a configuration of an MME in the first embodiment.

FIG. 3 is a block diagram showing a configuration of a mobile terminal in the first embodiment.

FIG. 4 is a block diagram showing a configuration of an eNB in the first embodiment.

FIG. 5 is a block diagram showing a configuration of an HeNB in the first embodiment.

FIG. 6 is a sequence diagram showing general system operations in the first embodiment.

FIG. 7 is a flow diagram showing operations of the MME in the first embodiment.

FIG. 8 is a flow diagram showing operations of the mobile terminal in the first embodiment.

FIG. 9 is an illustrative diagram of a configuration of a mobile communication system in a second embodiment of the present invention.

FIG. 10 is a block diagram showing a configuration of an MME in the second embodiment.

FIG. 11 is a block diagram showing a configuration of a mobile terminal in the second embodiment.

FIG. 12 is a sequence diagram showing general system operations in the second embodiment.

FIG. 13 is a flow diagram showing operations of the MME in the second embodiment.

FIG. 14 is a flow diagram showing operations of the mobile terminal in the second embodiment.

### DESCRIPTION OF EMBODIMENTS

Detailed description of the present invention will be given below. It is to be noted that the following detailed description and the accompanying drawings are not intended to limit the invention.

Mobile communication systems in embodiments of the present invention will be described below by using the drawings. The embodiments are illustrated in the contexts of mobile communication systems used as, e.g., systems for controlling inbound handovers.

### First Embodiment

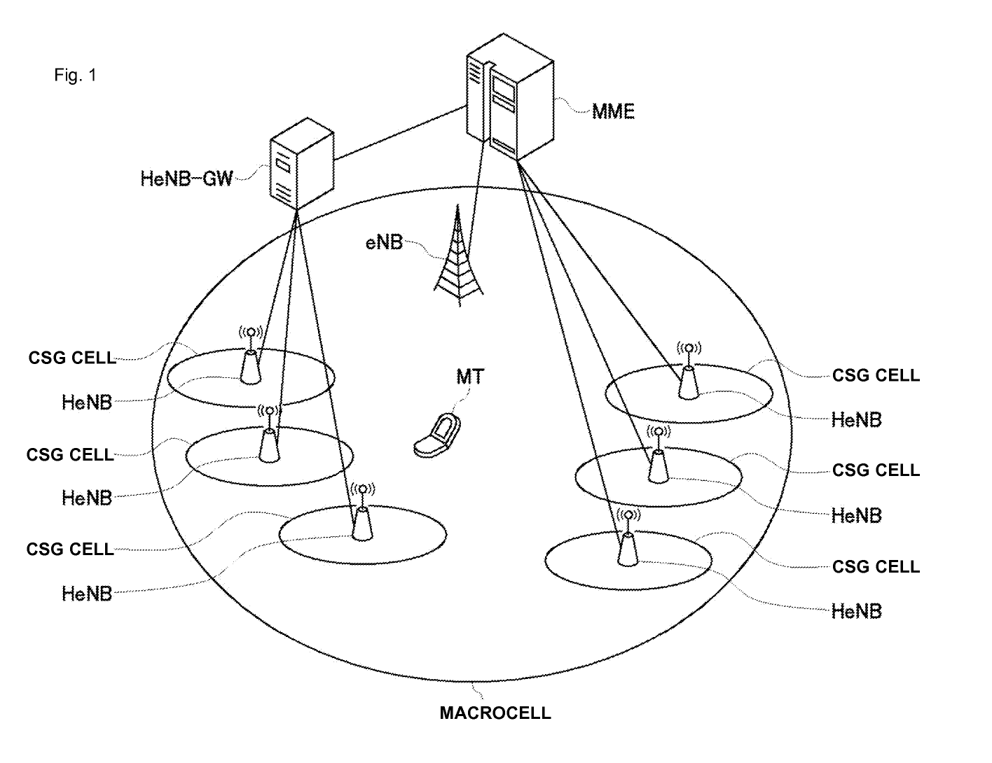

A configuration of a mobile communication system in a first embodiment of the present invention will be described with reference to the drawings. FIG. 1 is an illustrative diagram schematically showing the configuration of the mobile communication system in this embodiment. As shown in FIG. 1, the mobile communication system includes several CSG cells, each of which is implemented by a home base station (HeNB). Some of the home base stations (HeNBs) are directly connected to a mobility management entity (MME), and the other home base stations (HeNBs) are indirectly connected to the mobility management entity (MME) via a gateway (HeNB-GW). The CSG cells are disposed within the coverage of a base station (eNB) of a macrocell. The macrocell base station (eNB) is also connected to the MME through an interface.

Here, the eNB corresponds to a macrocell base station of the present invention. The HeNBs correspond to small cell base stations of the present invention, and the CSG cells correspond to small cells of the present invention. Further, the MME and the HeNB-GW correspond to a host device of the present invention. It is to be understood that all the home base stations (HeNBs) may be directly connected to the mobility management entity (MME) without the intervention of the gateway (HeNB-GW).

In the example of FIG. 1, a terminal device (also referred to as a mobile terminal) is initially in communication with the eNB, which is providing an operator's service to the mobile terminal through an interface. Thereafter, once the mobile terminal finds a CSG cell with high reception quality, the mobile terminal is controlled to hand over to that CSG cell. After the handover to the CSG cell, an HeNB provides the service to the mobile terminal through an interface. On a control plane, the eNB connects to the operator's core network control entity (i.e., the MME). The MME plays the role of managing access control for the mobile terminal: the MME has a function of determining to which home base stations the mobile terminal is granted access.

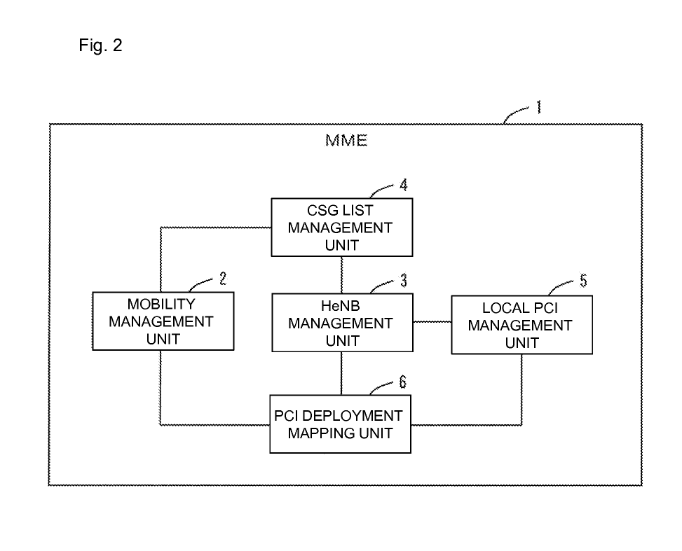

Next, with reference to the drawings, configurations of components of the mobile communication system in this embodiment will be described. FIG. 2 is a block diagram showing a configuration of the MME in this embodiment. As shown in FIG. 2, the MME 1 includes a mobility management unit 2, an HeNB management unit 3, a CSG list management unit 4, a local PCI management unit 5, and a PCI deployment mapping unit 6.

The mobility management unit 2 has a function of processing all signal communications for mobility management between the mobile terminal and the MME 1. The HeNB management unit 3 has a function of integrating IDs (e.g., CSG IDs, CGIs, and HeNB IDs) of HeNBs into a list. The CSG list management unit 4 is responsible for access control for the CSG cells.

For example, when a NAS procedure is started by the mobile terminal via the macrocell, the mobility management unit 2 asks the CSG list management unit 4 whether a list of CSG cells to which the mobile terminal is granted access is empty (queries the CSG list management unit 4 whether the mobile terminal is granted access to the CSG cells according to a corresponding subscriber profile) through an interface. If the list of CSG cells for which access is granted is not empty, the CSG list management unit 4 contacts the HeNB management unit 3 through an interface to compile a list of IDs (i.e., CSG IDs, CGIs, and HeNB IDs) of HeNBs (by narrowing down IDs to those of selected HeNBs) and responds to the MME 1. The HeNB management unit 3 further provides the list of the IDs of the selected HeNBs to the local PCI management unit 5 and the PCI deployment mapping unit 6 through an interface.

The local PCI management unit 5 has a function of compiling a list of local PCI map information about each of the selected HeNBs. For example, when a NAS procedure started by the mobile terminal triggers a procedure of generating PCI deployment map information (also referred to as PDM information), the MME 1 compiles a local PCI map for the selected HeNBs according to the stored local PCI map information (if the local PCI map information is available). Otherwise (if unavailable), the MME 1 contacts the selected HeNBs to acquire the local PCI map information. Once acquiring the local PCI map information about the selected HeNBs (the selected HeNBs are CSG cells to which the mobile terminal is granted access), the MME 1 provides the local PCI map information to the PCI deployment mapping unit 6 through an interface.

The PCI deployment mapping unit 6 has a function of generating the PDM information to be used by the eNB and the mobile terminal. For example, once the MME 1 obtains the IDs and the local map information of the selected HeNBs, the MME 1 maps the PCIs of the selected HeNBs to CGIs to generate PCI/CGI information. The PCI deployment mapping unit 6 passes this PDM information to the mobility management unit 2 through an interface. The mobility management unit 2 then transfers the PDM information to the eNB.

In this case, the HeNB management unit 3 receives cell position information including ID information about CSG cells around the mobile terminal from the eNB (or the HeNB) on which the mobile terminal is camping. Therefore the HeNB management unit 3 corresponds to cell position information reception means of the present invention. Also, according to the received cell position information, the CSG list management unit 4 identifies CSG cells which are around the mobile terminal and to which the mobile terminal is granted access, by using the ID information about the CSG cells. Therefore the CSG list management unit 4 corresponds to small cell identification means of the present invention.

Also in this case, the local PCI management unit 5 obtains, from the HeNBs for the identified CSG cells, the local map information including the PCIs of the identified CSG cells and PCIs of CSG cells around the identified CSG cells. Therefore the local PCI management unit 5 corresponds to local map information acquisition means of the present invention. According to the obtained local map information, the PCI deployment mapping unit 6 generates PCI deployment mapping information including at least information indicating the correspondences between the physical cell IDs and unique cell IDs of the CSG cells for which access is granted. Therefore the PCI deployment mapping unit 6 corresponds to deployment map information generation means of the present invention.

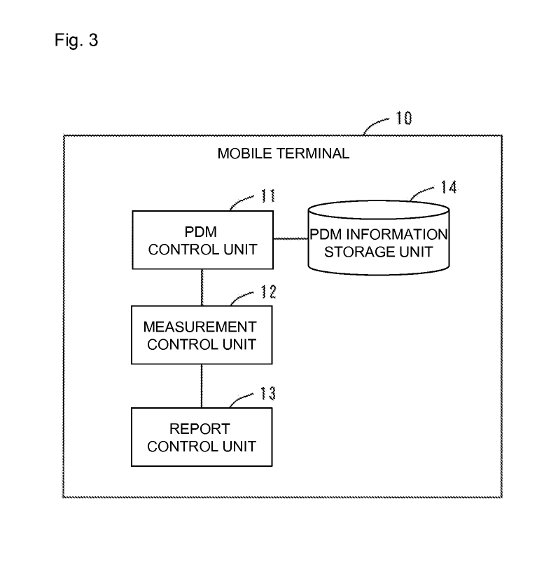

FIG. 3 is a block diagram showing an exemplary configuration of the mobile terminal in this embodiment. As shown in FIG. 3, the mobile terminal 10 includes a PDM control unit 11, a measurement control unit 12, and a report control unit 13.

The PDM control unit 11 is provided with a PDM information storage unit 14 for storing the PDM information including the PCI/CGI mapping information. For example, when the PDM information is transmitted from the eNB to the mobile terminal 10 through an RRC connection reconfiguration message, the PDM control unit 11 performs the process of storing the PDM information in the PDM information storage unit 14. When the mobile terminal 10 is triggered to start monitoring the wireless state of the serving cell and neighboring cells, the stored PDM information is provided to the measurement control unit 12 through an interface. In this case, the PDM control unit 11 receives the PDM information generated by the MME 1. Therefore the PDM control unit 11 corresponds to deployment map information reception means of the present invention. The PDM information storage unit 14 corresponds to deployment map information storage means of the present invention.

The measurement control unit 12 has a function of performing a reception quality measurement process of the mobile terminal 10 according to the PDM information. If measured values of the reception quality satisfy a report threshold value, the measurement control unit 12 passes the PDM information and detected PCIs to the report control unit 13 through an interface.

The report control unit 13 has a function of analyzing whether the detected PCIs are of CSG cells accessible to the mobile terminal 10 before starting setting of the detected PCIs in a measurement result report. For example, when the report control unit 13 obtains a list of the detected PCIs, the report control unit 13 checks the list for entries of the PDM information to thereby determine whether the detected PCIs are of accessible CSG cells. If it is determined that a detected PCI and any entry of the PDM information have the same PCI value, the mobile terminal 10 includes that PCI into the report message along with the CGI information. Here, this control unit corresponds to measurement result report generation means of the present invention.

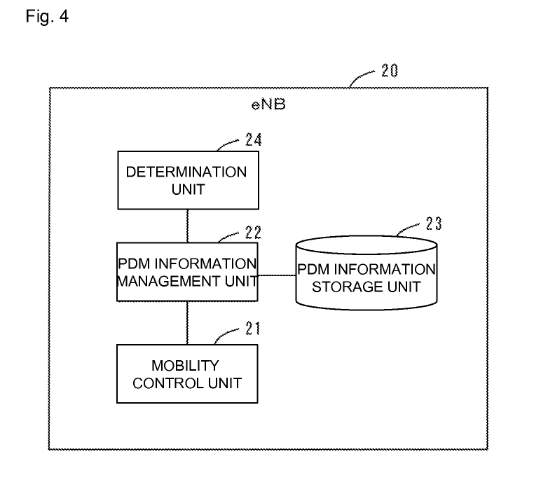

FIG. 4 is a block diagram showing an exemplary configuration of the eNB in this embodiment. As shown in FIG. 4, the eNB 20 includes a mobility control unit 21 and a PDM information management unit 22. The mobility control unit 21 has a function of processing all signal communications for handovers between the mobile terminal 10 and the eNB 20. The mobility control unit 21 receives the PDM information generated by the MME 1. Therefore the mobility control unit 21 may correspond to the deployment map information reception means of the present invention.

The PDM information management unit 22 has a function of processing the PDM information. The PDM information management unit 22 is provided with a PDM information storage unit 23 for storing the PDM information provided from the MME 1. The PDM information also passes the PDM information to the mobility control unit 21 through an interface. The mobility control unit 21 then transfers the PDM information to the mobile terminal 10.

The eNB 20 may include a determination unit 24 that determines whether or not access to a CSG cell included in the measurement result report received from the mobile terminal 10 is granted according to the PDM information if two or more CSG cells having the same ID information are disposed within the macrocell. Including such determination unit 24 enables the eNB 20 to make a determination of a handover (an inbound handover from a macrocell to a CSG cell).

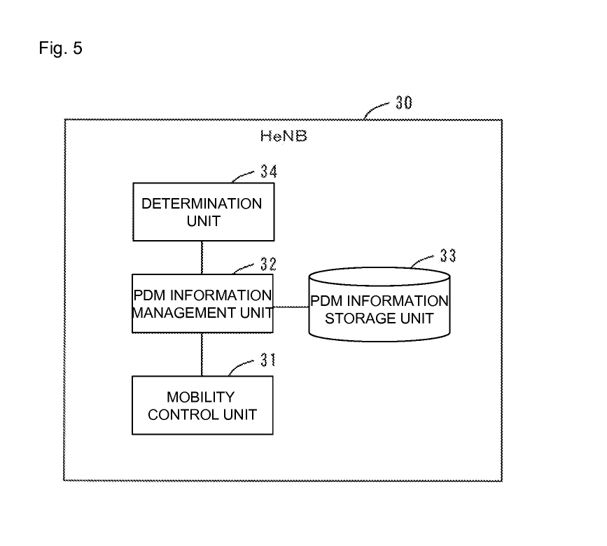

FIG. 5 is a block diagram showing an exemplary configuration of the HeNB in this embodiment. As shown in FIG. 5, the HeNB 30 has the same configuration as the eNB 20 and includes a mobility control unit 31 and a PDM information management unit 32. The mobility control unit 31 has a function of processing all signal communications for handovers between the mobile terminal 10 and the HeNB 30. The mobility control unit 31 receives the PDM information generated by the MME 1. Therefore the mobility control unit 31 may correspond to the deployment map information reception means of the present invention.

The PDM information management unit 32 has a function of processing the PDM information. The PDM information management unit 32 is provided with a PDM information storage unit 33 for storing the PDM information provided from the MME 1. The PDM information also passes the PDM information to the mobility control unit 31 through an interface. The mobility control unit 31 then transfers the PDM information to the mobile terminal 10.

The HeNB 30 may include a determination unit 34 that determines whether or not access to a CSG cell included in the measurement result report received from the mobile terminal 10 is granted according to the PDM information if two or more CSG cells having the same ID information are disposed within the macrocell. Including such determination unit 34 enables the HeNB 30 to make a determination of a handover (an inbound handover from a CSG cell to a CSG cell).

Operations of the mobile communication system in the first embodiment configured as above will be described with reference to the drawings.

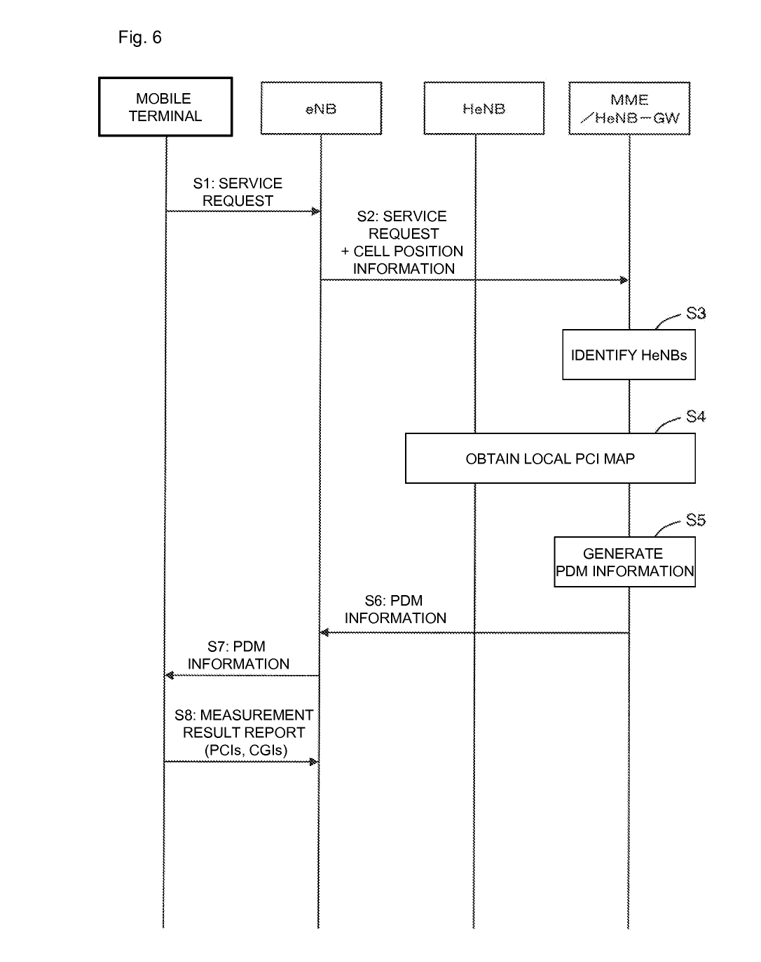

First, general system operations where a handover is controlled in the mobile communication system in the first embodiment will be described by using a sequence diagram of FIG. 6. The example of FIG. 6 illustrates operations through which the eNB 20 and the mobile terminal 10 obtain the PCI deployment map information (the PDM information) in a service session setup process.

As shown in FIG. 6, first, when the mobile terminal 10 is camping on the eNB 20, the mobile terminal 10 starts a service session by transmitting a service request to the eNB 20 (S1). The eNB 20, having received the service request, selects a corresponding MME 1 and transfers the service request to the MME 1 through an interface, where the eNB 20 attaches cell position information about the eNB 20 to the service request (S2). The cell position information includes, for example, area information (area information that the MME 1 understands) such as a tracking area identifier (TAI), and/or an identification of the eNB 20 (ECGI).

The MME 1, having received the service request, performs corresponding service control operations. After these regular operations, the MME 1 further identifies HeNBs 30 for which access is granted in the neighborhood of the mobile terminal 10, according to subscriber information about the mobile terminal 10 such as a list of CSG cells for which access is granted (a list of HeNBs 30) and the current position of the mobile terminal 10 such as the TAI of the currently serving cell (S3). Here, the current position of the mobile terminal 10 may be obtained from the service request. The list of the HeNBs 30 may be obtained from the HeNBs 30 via the HeNB-GW (or without the intervention of the HeNB-GW). The list of the HeNBs 30 may also be generated according to other criteria, for example the relationships between the CSG cells and the macrocell, information about TAIs at the same location stored in advance in the MME 1, or specified operator roaming agreement. When more than one CSG cell exists for one HeNB 30, the MME 1 may identify an actual CSG cell instead of the HeNB 30.

According to the list of the HeNBs 30 (or the list of IDs of the CSG cells) for which access is granted, the MME 1 requests the local PCI map information from each of the identified HeNBs 30 to obtain the local PCI map information (S4). For example, the local PCI map information includes PCIs of the selected HeNBs 30 and PCIs of CSG cells in the neighborhood of the HeNBs 30. Alternatively, the list of the local PCI map information may be generated from information stored in the MME 1. As an example, the MME 1 may obtain and store the local PCI map information in advance. As another example, the MME 1 may obtain in advance the PCI of each CSG cell on the list of the CSG cells to which the mobile terminal 10 is granted access.

Once the MME 1 obtains the local PCI map information, the MME 1 compiles the PCI deployment map (the PDM) and generates the PCI deployment map information (the PDM information) (S5). The PDM information includes a list of physical cell IDs (PCIs) of the CSG cells for which access is granted and their associated cell global IDs (CGIs) (i.e., the PCI/CGI map). For example, representative PDM information entries may include the following information.

PCI-1 PDM-1: :=[CGI-1,
(optional) CSG-ID-1,
(optional) HeNB-ID-1];

PCI-2 PDM-2: :=[CGI-2,
(optional) CSG-ID-2,
(optional) HeNB-ID-2];

PCI-3 PDM-3: :=[CGI-3,
(optional) CSG-ID-3,
(optional) HeNB-ID-3];

For example, if the mobile terminal 10 reports PCI-2, PCI-4, and PCI-9 in the measurement report and the eNB 20 finds that the cell of PCI-2 has better wireless quality, the eNB 20 checks the PDM information entries in preparation for a handover. In the above example, the eNB 20 detects a PDM information entry for PCI-2. Then the eNB 20 can use PDM-2 to map PCI-2 to CGI-2 and can also obtain other necessary information in preparation for the handover, such as CSG-ID-2 and HeNB-ID-2. After obtaining these pieces of information, the eNB 20 starts regular handover operations.

The MME 1 may generate the PDM information from information collected at various stages. Each HeNB 30 needs to provide its HeNB-ID in order to register with the HeNB-GW. Therefore the HeNB-GW may compile a list of HeNB-IDs of HeNBs 30 within the tracking area covered by the HeNB-GW. If the HeNB-GW does not exist, the MME 1 holds the list of HeNB-IDs.

When the PDM information needs to be generated such as after receiving a service request, the MME 1 narrows down the HeNBs 30 to selected ones by identifying only HeNBs 30 serving the same tracking area as the current cell of the mobile terminal 10. The MME 1 may obtain a list of these HeNBs 30 by transmitting the list of the CSG to which the mobile terminal 10 is granted access, and the TAI of the cell on which the mobile terminal 10 is currently camping, to the corresponding HeNB-GW covering the area. The HeNB-GW identifies HeNBs 30 having the CSG-IDs serving the tracking area of the TAI and returns the list of the HeNBs 30 to the MME 1 (S3).

If the HeNB-GW does not exist, the MME 1 has knowledge about the information that would be available in the HeNB-GW, for example the IDs and positions of the HeNBs 30 and the tracking area covered by the HeNBs 30. In this case, the MME 1 can directly generate the narrowed down HeNB-ID list.

After obtaining the HeNB-ID list, the MME 1 may obtain further information for generating the PDM information. For example, such information may include the PCIs and CGIs currently used by the HeNBs 30, and PCIs recognized by the HeNBs 30 in their neighborhood. The MME 1 may obtain these pieces of information by directly contacting the HeNBs 30 (S4). Alternatively, the MME 1 may obtain these pieces of information through other interfaces, such as an HeNB management interface, or from some management database for the HeNBs 30, for example.

The MME 1 transmits the PDM information to the eNB 20, for example along with an initial context setup request message (S6). The eNB 20, having received the initial context setup request, stores the PDM information and starts radio bearer establishment for the mobile terminal 10. The radio bearer establishment message may be an RRC connection reconfiguration message specified in 3GPP. For example, the eNB 20 embeds the PDM information into the radio bearer establishment message to be transmitted to the mobile terminal 10 (S7).

The mobile terminal 10, having received the radio bearer establishment message, stores the PDM information for later use and proceeds to any operation necessary for radio bearer establishment. For example, the mobile terminal 10 transmits an RRC connection reconfiguration completion message to the eNB 20. Thereafter, when the measured reception quality for adjacent cells satisfies the threshold value, the mobile terminal 10 reports the measured cells to the network. At this time, the mobile terminal 10 may include CGI information corresponding to the PCIs into the PDM information (S8).

For example, the mobile terminal 10 may report CGI-1 and CGI-2 along with PCI-1 and PCI-2. The CGI information is obtained from the PDM of corresponding PCI entries in the PDM information. The mobile terminal 10 transmits the CGI information to the eNB 20 through the measurement result report, along with some pieces of expansion information carrying additional information. The eNB 20 can thereby use the first report message to know the CGIs corresponding to the PCIs reported by the mobile terminal 10. Therefore the eNB 20 can determine to perform an inbound handover to an accessible CSG cell without further delay. This eliminates the need for, for example, the second measurement result report from the mobile terminal 10 for obtaining the CGI information.

It is apparent to those skilled in the art that the mobile terminal 10 may not include the CGIs into the measurement report but may report only the PCIs. In this case, the eNB 20 needs to use the stored PDM information to map the PCIs to the corresponding CGIs. This process naturally involves other operations such as operations specified for the service request procedure of the mobile terminal 10, which will not be described here.

In the above-described approach, the PDM information is generated and transmitted to the mobile terminal 10 through the service request procedure triggered by the mobile terminal 10. In actual embodiments, if an “active” flag is set in a tracking area update (TAU) message transmitted from the mobile terminal 10, the PDM information may be generated during a TAU process. For example, a change of the TAI may cause the MME 1 to update the PDM information for the mobile terminal 10.

The PDM information does not need to be unique to the cell that is serving the mobile terminal 10. For example, the mobile terminal 10 may be surrounded by several CSG cells for which access is granted, such as in an office of a company or in a school building. Accordingly, upon a handover operation, the PDM information depending on the locations of neighboring cells may be updated and, if necessary, transmitted to the mobile terminal 10 and a corresponding new eNB 20/HeNB 30. This update process may be triggered by a handover command message transmitted from the handover-source eNB 20/HeNB 30, so that the PDM information may be updated and transmitted to the mobile terminal 10 in the handover command message. The handover-destination eNB 20/HeNB 30 receives the PDM information as part of a handover request message.

The eNB 20 may refresh the mobile terminal 10 with the new PDM information when the PDM information is updated by the network. This may be performed with an RRC connection reconfiguration message for, e.g., measurement setting.

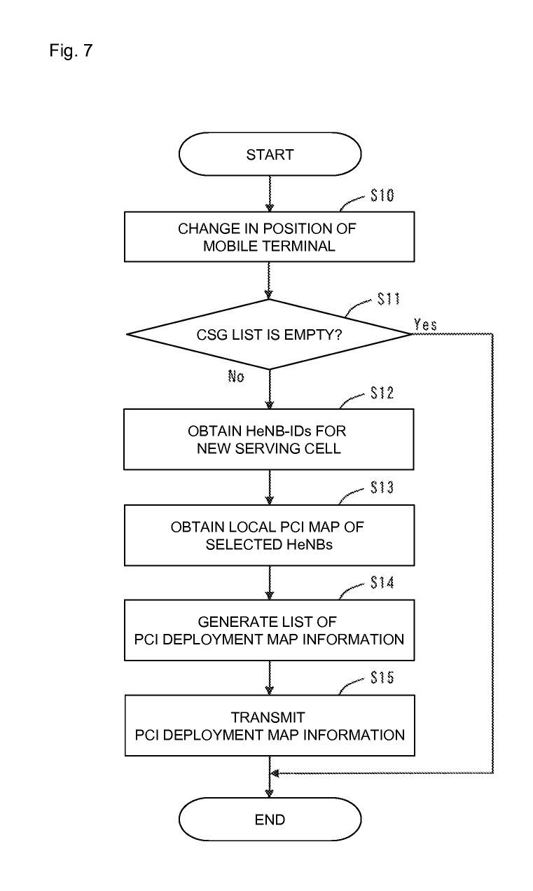

Next, operations of the MME 1 where a handover is controlled in the mobile communication system in the first embodiment will be described with reference to a flow diagram of FIG. 7. As shown in FIG. 7, in this case, the CSG list management unit 4 is first notified of a change in the position of the mobile terminal 10 by the mobility management unit 2 (S10).

Notified of the change in the position of the mobile terminal 10, the CSG list management unit 4 checks whether a list of CSG cells to which the mobile terminal 10 is granted access is empty (S11). If the list is not empty, the CSG list management unit 4 notifies the HeNB management unit 3 and compiles an HeNB-ID list to obtain HeNB-IDs for the new serving cell (S12). At this point, the HeNB management unit 3 triggers the HeNB-GW to compile the HeNB-ID list. If the HeNB-GW does not exist, the list is obtained from information in the MME 1 itself or from some HeNB management entity.

The selected HeNB-IDs are provided to the local PCI management unit 5 and used for performing a local PCI map procedure. The local PCI management unit 5 contacts the selected HeNBs 30 to obtain the local PCI map information (S13) and provides this information to the MME 1. If the local PCI map information about the selected HeNBs 30 is stored in advance and still valid for the mobile terminal 10, for example if the positions of the selected HeNBs 30 have not changed, the local PCI map information about the selected HeNBs 30 may be obtained from the MME 1. Once obtaining the local PCI map information, the local PCI management unit 5 provides the information to the PCI deployment mapping unit 6.

The PCI deployment mapping unit 6 then obtains the selected HeNB-IDs from the HeNB management unit 3 and generates the PDM information including the PCI/CGI mapping information according to the selected HeNB-IDs and the local PCI map information about the selected HeNBs 30 (S14). The PCI deployment mapping unit 6 sends the PDM information to the mobility management unit 2, which transmits the PDM information to the eNB 20 through an S1AP message (S15).

It is to be understood that the PCI deployment mapping unit 6 may take into other information into account in generating the PDM information, for example the position of the mobile terminal 10, information about cells on which the mobile terminal 10 previously camped, the relationships among the HeNBs 30, the relationships between the HeNBs 30 and the eNB 20, the load state of the system, and the cost of accessing the system.

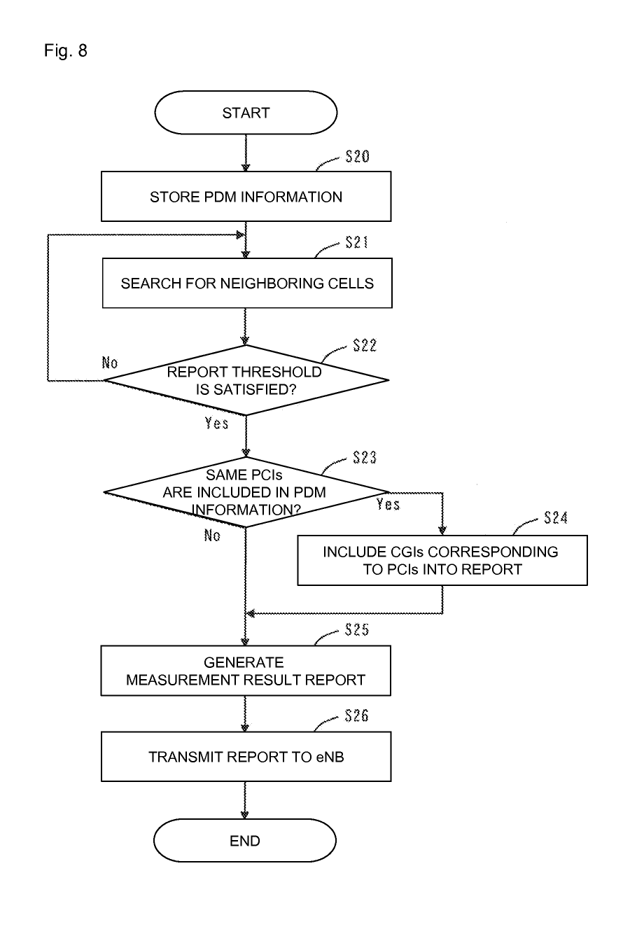

Next, operations of the mobile terminal 10 where a handover is controlled in the mobile communication system in the first embodiment will be described with reference to a flow diagram of FIG. 8. As shown in FIG. 8, the PDM control unit 11 first receives an RRC connection reconfiguration message to store the PDM information transmitted along with the RRC connection reconfiguration message (S20).

The mobile terminal 10 then starts a reception quality measurement process to search for neighboring cells that are in a better radio condition (S21). During monitoring the neighboring cells, the mobile terminal 10 checks whether the reception quality for the cells satisfies a report threshold value (S22). If the report threshold value is not satisfied, the mobile terminal 10 continues searching for other neighboring cells. If the report threshold value is satisfied, the mobile terminal 10 checks whether PCIs of the same values as the detected PCIs are included in the PDM information entries (S23).

If PCIs of the same values as the detected PCIs are included in the PDM information, the mobile terminal 10 includes the PCIs into a report message as report PCIs associated with CGI values corresponding to the PCIs (S24). Once a measurement result report including the PCIs and the CGIs is generated in this manner (S25), the mobile terminal 10 transmits the report message to the eNB 20 through the measurement result report (S26).

If the same PCI values are not found in the PDM information, the mobile terminal 10 generates a measurement result report including only the detected PCIs (S25) and transmits the measurement result report to the eNB 20 (S26).

According to the above mobile communication system in the first embodiment of the present invention, appropriate handover control can be performed without adding further delay. This embodiment introduces the cell ID deployment mapping approach. In this approach, information about the cell on which the mobile terminal 10 is currently camping is generated from the measurement report, and the list of the PCI deployment map information (the PDM information) is generated from the PCIs of the CSG cells available to the mobile terminal 10 stored in the MME 1. The PDM information includes at least the PCI/CGI mapping information about the mobile terminal 10. To generate the PDM information through the cell ID deployment mapping approach, input parameters need to be received from the mobile terminal 10 side and the core network side. The cell ID deployment mapping approach is used by the core network entity (i.e., the MME 1) and the HeNB-GW. Once the MME 1 (or the HeNB-GW) generates the PDM information, the MME 1 (or the HeNB-GW) provides the PDM information to the mobile terminal 10 and the eNB 20 (or the HeNB 30) through respective downlink signals for the eNB 20 and the terminal. The terminal device can use the PDM information to appropriately control the handover. It is to be noted that the eNB 20 (or the HeNB 30) may use the PDM information to control the handover according to the PCIs reported from the mobile terminal 10. In this case, the use of the PDM information including the PCI/CGI mapping information enables the eNB 20 (or the HeNB 30) to sufficiently perform appropriate handover control only with the PCIs transmitted from the mobile terminal 10 in the first measurement result report. Therefore, again in this case, the delay due to the necessity of the second measurement report is resolved.

The mobile communication system in this embodiment is a mobile communication system in which a handover of a terminal device (mobile terminal 10) from a macrocell base station (eNB 20) to a small cell base station (HeNB 30) is controlled via a host device (MME 1/HeNB-GW). The host device includes: cell position information reception means for receiving cell position information including identification information (ID information) about small cells (CSG cells) around the terminal device from the macrocell base station or a small cell base station on which the terminal device is camping; small cell identification means for, according to the received cell position information, identifying small cells which are around the terminal device and to which the terminal device is granted access, by using the identification information about the small cells; local map information acquisition means for acquiring local map information from small cell base stations for the identified small cells, the local map information including physical cell IDs (PCIs) of the identified small cells and physical cell IDs of small cells around the identified small cells; and deployment map information generation means for, according to the acquired local map information, generating physical cell ID deployment map information (PCI deployment map information) including at least information (PCI/CGI map information) indicating correspondences between the physical cell IDs (PCIs) and unique cell IDs (CGIs) of the small cells for which access is granted. The terminal device includes: deployment map information reception means for receiving the physical cell ID deployment map information generated by the host device from the host device; and measurement result report generation means for generating a measurement result report of reception quality by using the physical cell ID deployment map information when a request to measure the reception quality for small cells around the terminal device for controlling a handover to any of the small cells is received via the host device.

With the above configuration, the host device generates the PCI deployment map information (the PDM information) including the PCI/CGI map information, and the terminal device uses the PCI deployment map information (the PCI/CGI map information included therein) to generate the measurement result report for use in controlling the handover to a small cell around the terminal device. For example, the terminal device may include not only the PCIs but also the CGIs into the first measurement result report. Accordingly, even if two or more small cells having the same PCI exist within the macrocell, an accessible small cell can be identified with the CGI. This enables preventing a service interruption caused by performing handover control to an inaccessible small cell. Also, the need of the second measurement report conventionally required for CGI notification is eliminated, which enables a reduction in the wait time for handover control correspondingly.

In this embodiment, the terminal device is configured to include deployment map information storage means for storing the physical cell ID deployment map information received from the host device.

With the above configuration, the terminal device. can use the PCI deployment map information stored in advance to generate the measurement result report for use in performing the handover to a small cell around the terminal device.

### Second Embodiment

A mobile communication system in a second embodiment of the present invention will be described. Here, the mobile communication system in the second embodiment will be described mainly with respect to what are different from the first embodiment. Accordingly, unless otherwise stated herein, configurations and operations in this embodiment are the same as the first embodiment.

In the first embodiment, the mobile terminal (MT) simply reports the PCIs and the CGIs when the same PCI values are found in the PDM information. In the system in the second embodiment, different HeNBs within the same macrocell can be given the same PCI value without causing interference with each other. That is, this embodiment can also address a scenario such that different HeNBs having the same PCI value are remotely located within the same macrocell.

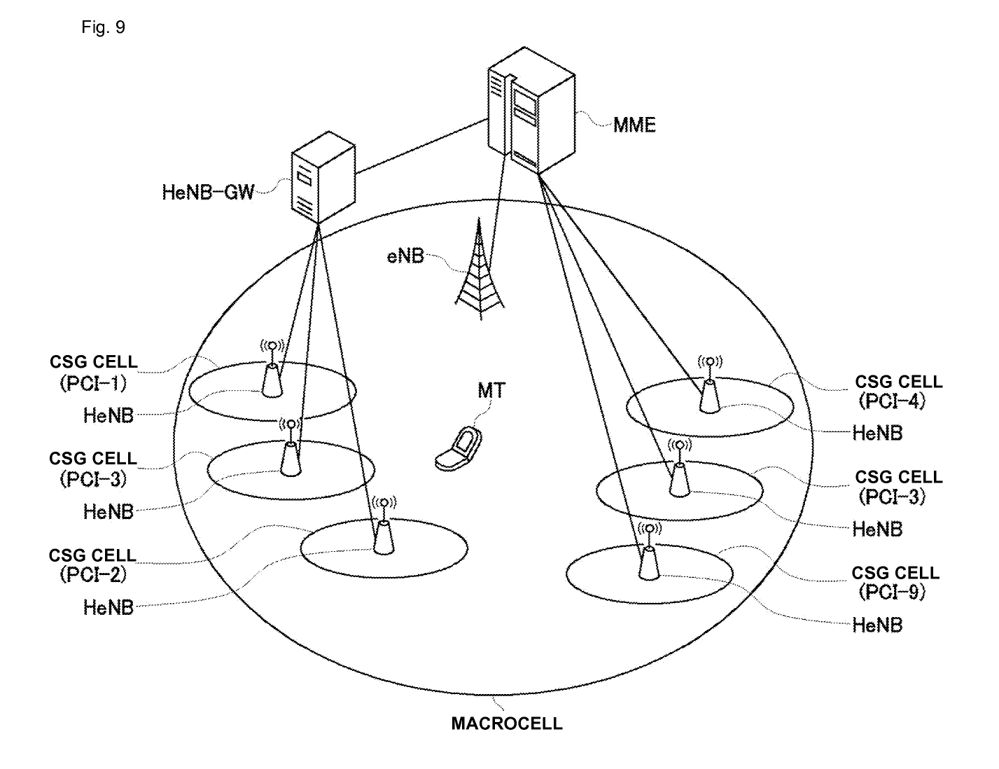

For example, as shown in FIG. 9, two CSG cells within a macrocell may be remotely located while taking the same PCI value (PCI-3). The PCI detected by the mobile terminal (MT) may be included in the PDM information, but the PCI may be of a CSG cell that the mobile terminal actually cannot access (that is, a PCI collision may occur). As described below, this embodiment can address such a PCI collision.

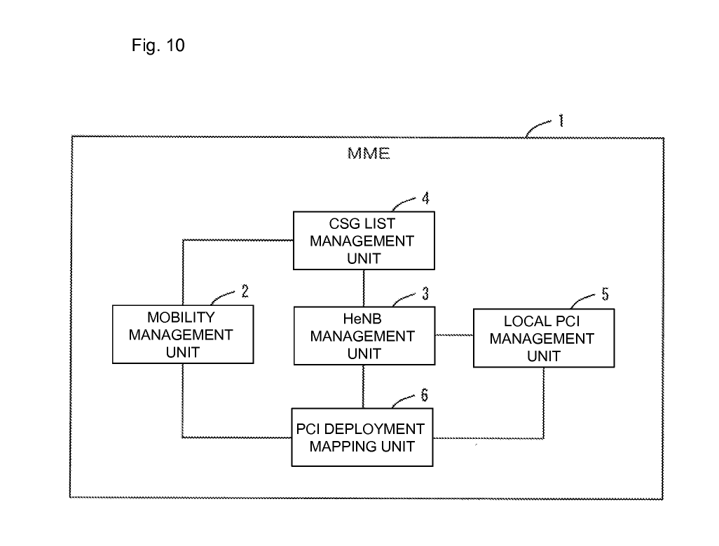

First, with reference to the drawings, configurations of components of the mobile communication system in this embodiment will be described. FIG. 10 is a block diagram showing a configuration of an MME 1 in this embodiment. As shown in FIG. 10, the MME 1 includes a mobility management unit 2, an HeNB management unit 3, a CSG list management unit 4, a local PCI management unit 5, and a PCI deployment mapping unit 6. The PCI deployment mapping unit 6 in this embodiment can also determine blacklisted inter-PCI map (BIPM) information from the local PCI map information. The BIPM information is included in the PDM information along with the PCI/CGI map information.

Thus, the PDM information also includes the blacklisted inter-PCI map (BIPM) information that can be used by the eNB 20 and the mobile terminal 10 for performing an inbound handover to a CSG cell. For example, using PCIs reported from the mobile terminal 10, the eNB 20 can determine whether a certain reported PCI can be mapped to a CGI by the PDM information according to whether the reported PCIs match PCIs included in a corresponding BIPM entry. In this case, representative PDM information entries may include the following information.

PCI-1 PDM-1: :=[CGI-1,
(optional) CSG-ID-1,
(optional) HeNB-ID-1];

BIPM-1: :=[PCI-4, PCI-5, PCI-6];

PCI-2 PDM-2: :=[CGI-2,
(optional) CSG-ID-2,
(optional) HeNB-ID-2];

BIPM-2: :=[PCI-6, PCI-7, PCI-8];

PCI-3 PDM-3: :=[CGI-3,
(optional) CSG-ID-3,
(optional) HeNB-ID-3];

BIPM-3: :=[PCI-9, PCI-10, PCI-11];

For example, if the mobile terminal 10 reports PCI-2, PCI-4, and PCI-9 in the measurement report and the eNB 20 finds that the cell of PCI-2 has better wireless quality, the eNB 20 checks the PDM information entries in preparation for a handover. In the above example, the eNB 20 detects a PDM information entry for PCI-2 and checks whether the reported PCIs, i.e., PCI-4 and PCI-9 match BIPM-2 associated with PCI-2. Since the reported PCIs do not exist in BIPM-2, the eNB 20 can use PDM-2 to map PCI-2 to CGI-2 and can also obtain other necessary information in preparation for the handover, such as CSG-ID-2 and HeNB-ID-2. After obtaining these pieces of information, the eNB 20 starts regular handover operations.

To generate the PDM information, the MME 1 needs to integrate all information such as, for example, the positional relationships and the PCI relationships among the HeNBs 30. For example, if the MME 1 recognizes that two HeNBs 30 are remotely located, PCIs of CSG cells adjacent to one HeNB 30 is not known to the mobile terminal 10 connected to the other HeNB 30. In this case, the MME 1 can readily compile the BIPM for CSG cells adjacent to each HeNB 30 from the positional information collected from the HeNB-GW or the HeNBs 30.

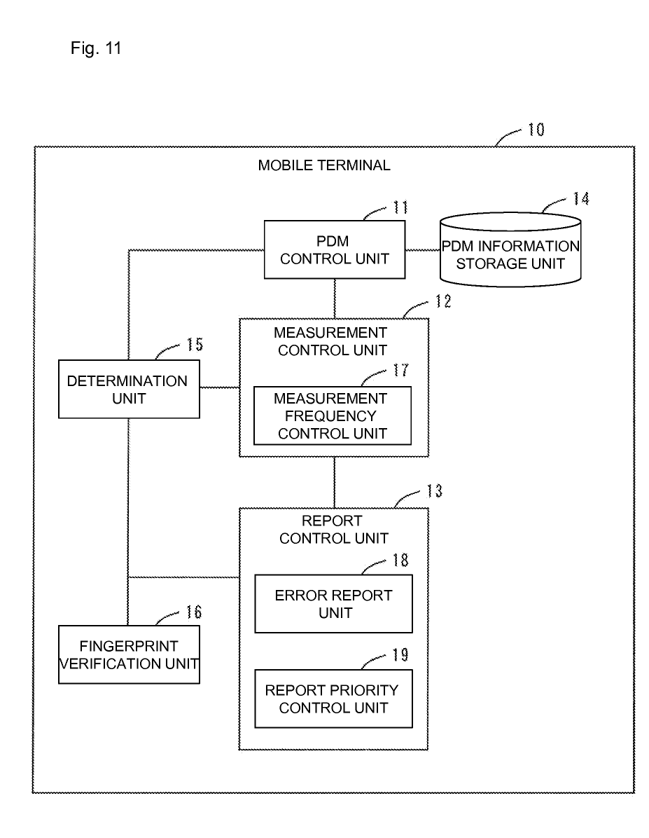

FIG. 11 is a block diagram showing an exemplary configuration of a mobile terminal 10 in this embodiment. As shown in FIG. 11, the mobile terminal 10 includes a PDM control unit 11, a measurement control unit 12, a report control unit 13, a determination unit 15, and a fingerprint verification unit 16.

The PDM control unit 11 is provided with a PDM information storage unit 14 for storing the PDM information. The PDM information storage unit 14 stores the PCI/CGI mapping information and the blacklisted inter-PCI map (BIPM) information.

The measurement control unit 12 includes a measurement frequency control unit 17: for example, when the mobile terminal 10 measures the reception quality, the measurement frequency control unit 17 can prioritize cells corresponding to PCIs included in the PDM information for reception quality measurement. For example, the measurement frequency control unit 17 performs control so that the measurement frequency for a cell corresponding to a PCI included in the PDM information becomes higher than that for other cells. Also, when the determination unit 15 (to be described below) determines that access to a CSG cell identified by using ID information about the CSG cell is not granted, the measurement frequency control unit 17 controls to lower the frequency of measuring the reception quality for the determined CSG cell.

The determination unit 15 has a function of, if two or more CSG cells having the same ID information are disposed within a macrocell, determining whether or not access to the CSG cells identified by using the ID information about the CSG cells is granted according to the PCI deployment map information (the blacklisted inter-PCI map information included therein).

The report control unit 13 includes an error report unit 18 that transmits, when the determination unit 15 determines that access to the CSG cell identified by using ID information about the CSG cell is not granted, an error report to the MME 1 about the determined CSG cell. The report control unit 13 also includes a report priority control unit 19 that controls, when the determination unit 15 determines that access to a CSG cell identified by using ID information about the CSG cell is not granted, to heighten the priority in transmitting the measurement result report to the MME 1 for a CSG cell around the determined CSG cell and included in the PCI deployment map information.

The fingerprint verification unit 16 has a function of verifying fingerprint information including physical cell ID information about previously accessed small cells according to a determination result of the determination unit 15. The mobile terminal 10 may have a function of storing, as the fingerprint information, position information about previously camped-on CSG cells and PCIs and CGIs of these cells, and, if a CSG cell having the same PCI as a PCI stored as the fingerprint information is detected, determining whether the detected CSG cell is a previously camped-on CSG cell according to the position information stored along with the PCI. As the fingerprint information, only information about CSG cells accessible to the mobile terminal 10 is stored.

The fingerprint verification unit 16 has a function of being capable of using the blacklisted inter-PCI map (BIPM) information to ensure that a PCI stored as the fingerprint information is still valid. For example, from a PCI of an adjacent CSG cell detected by the mobile terminal 10, it may be determined that a PCI stored as the fingerprint information is a PCI corresponding to a CSG cell determined as inaccessible according to the blacklisted inter-PCI map (BIPM): this implies that the information about the PCI in the fingerprint information is invalid. Therefore, in such a case, the mobile terminal 10 updates the fingerprint information or completely ignores the fingerprint information about such PCIs. Otherwise, the mobile terminal 10 can consider the PCI information in the fingerprint information as still valid. In this case (if the fingerprint information is valid), the mobile terminal 10 can include the CGI information into the reception quality report message directed to the network.

Operations of the mobile communication system in the second embodiment configured as above will be described with reference to the drawings.

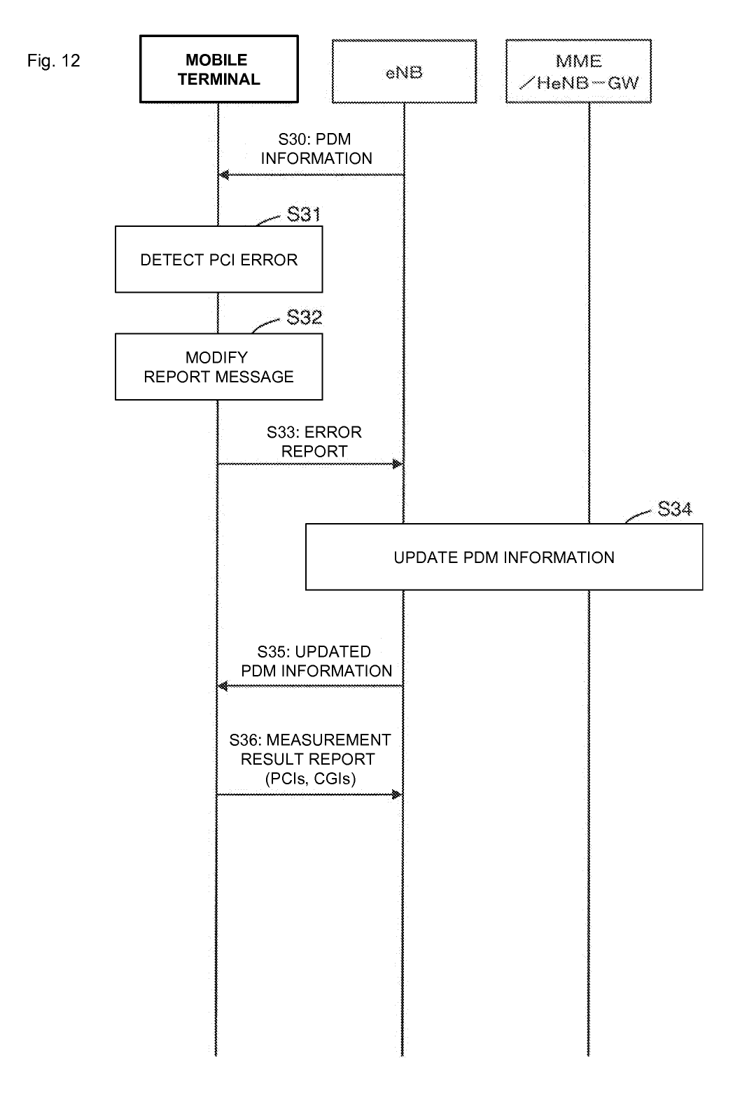

FIG. 12 is a sequence diagram where the PDM information is used in the mobile communication system in the second embodiment. As shown in FIG. 12, first, an RRC connection reconnection message including the PDM information is transmitted from the eNB 20 to the mobile terminal 10 (S30). After receiving the PDM information, the mobile terminal 10 performs an additional check procedure by using the blacklisted inter-PCI map (BIPM) information included in the PDM information. The blacklisted inter-PCI map (BIPM) information includes a list of PCIs of adjacent cells that should not be detected when the mobile terminal 10 camps on a cell having a certain PCI. Accordingly, if these adjacent PCIs are detected, it means that the cell having the certain PCI is a CSG cell inaccessible to the mobile terminal 10.

If a detected PCI is included in the PDM information and is also determined as a CSG cell inaccessible to the mobile terminal 10 according to the BIPM, the mobile terminal 10 considers that the detected PCI is also used for another CSG cell within the same macrocell (a PCI collision). When the error of the detected PCI is found in this manner (S31), the mobile terminal 10 can report information indicating the PCI collision along with the relevant PCI to the eNB 20.

The mobile terminal 10 does not, include a CGI corresponding to the colliding PCI into the reception quality report message. Instead, the mobile terminal 10 modifies the reception quality report message (S32) to include a PCI error notification and transmits the modified reception quality report message to the eNB 20 (S33).

As an exemplary way of the PCI error notification, the mobile terminal 10 may include an error “flag” indicating the PCI collision along with the detected PCI into the report message. Alternatively, in order to indicate that the detected PCI is of a CSG cell inaccessible to the mobile terminal 10, the mobile terminal 10 may include the PCI included in the BIPM information among other detected PCIs of adjacent CSG cells into the report message along with the detected colliding PCI.

At this point, measured cells are normally ranked in descending order of reception quality and included into the report message. If CSG cells more than the maximum number of reportable cells have reception quality above a reception quality measurement threshold value for cells to be included into the report message, the ranking order may be prioritized so that the report of the PCI included in the BIPM is given priority irrespective of the normal ranking order.

For example, it is assumed that a PCI of a CSG cell A is included in the blacklisted inter-PCI map (BIPM) for a PCI of another CSG cell B, and the mobile terminal 10 has detected the both CSG cells. If CSG cells more than the maximum number of cells that may be included in the report message have reception quality above the reception quality measurement threshold value for the report and if the CSG cell A is at a lower place in the report ranking, normally only the CSG cell B would be allowed to be included into the report message. In this case, the mobile terminal 10 can give priority to the report of the CSG cell A in the same report message as the CSG cell B. This allows the eNB 20 to know the presence of an error in the report message (i.e., the presence of the BIPM for a particular PCI in the same report message as the particular PCI).

A possible way to be taken when the network receives a notification of a report error is that the eNB 20 transmits the notification to the MME 1 to perform a PDM information update procedure (S34). Upon completion of updating the PDM information, the eNB 20 provides the updated PDM information to the mobile terminal 10 through an RRC connection reconfiguration message (S35). If the mobile terminal 10 finds no error according to the updated PDM information when the same PCI is again detected, the mobile terminal 10 transmits the report message to the eNB 20 with the PCI and CGI information included therein (S36).

Updating the PDM information is merely one possible way, and there are various alternative ways. For example, the eNB 20 may transmit a second reception quality measurement setting to the mobile terminal 10 to cause the mobile terminal 10 to verify the CGI information about the PCIs reported in the first reception quality measurement result report. The eNB 20 may also instruct a handover to a macrocell having the next highest reception quality when the eNB 20 receives a PCI error for a CSG cell reported by the mobile terminal 10.

Thus, the second embodiment is characterized in that the additional procedure for PCI collision error detection is performed by means of the blacklisted inter-PCI map (BIPM) information before the mobile terminal 10 composes the report message of the reception quality measurement result, and this feature has been described in detail above. Other features similar to those in the first embodiment will not be described here.

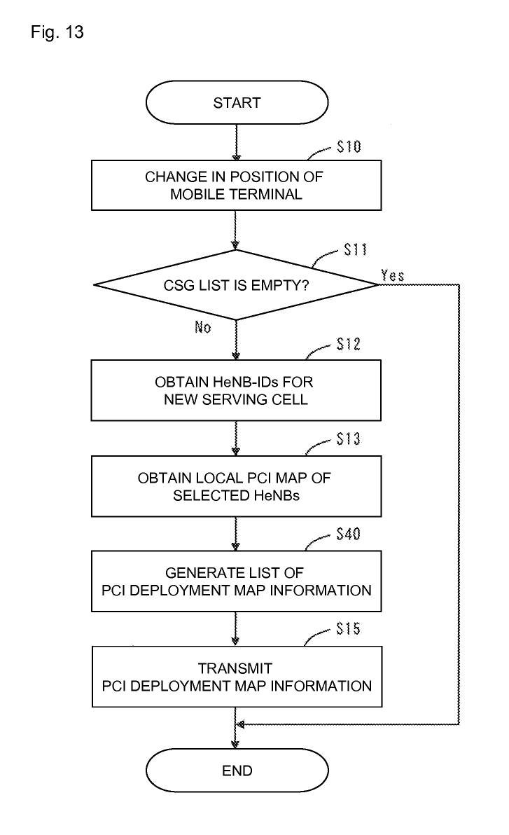

Next, operations of the MME 1 where a handover is controlled in the mobile communication system in the second embodiment will be described with reference to a flow diagram of FIG. 13. Here, operations of the MME 1 in this embodiment will be described mainly with respect to what are different from the first embodiment. The PCI deployment mapping unit 6 generates the PDM information, including the PCI/CGI mapping information and the blacklisted inter-PCI map (BIPM) information, according to the selected HeNB-IDs and the local PCI map information about the selected HeNBs 30 (S40).

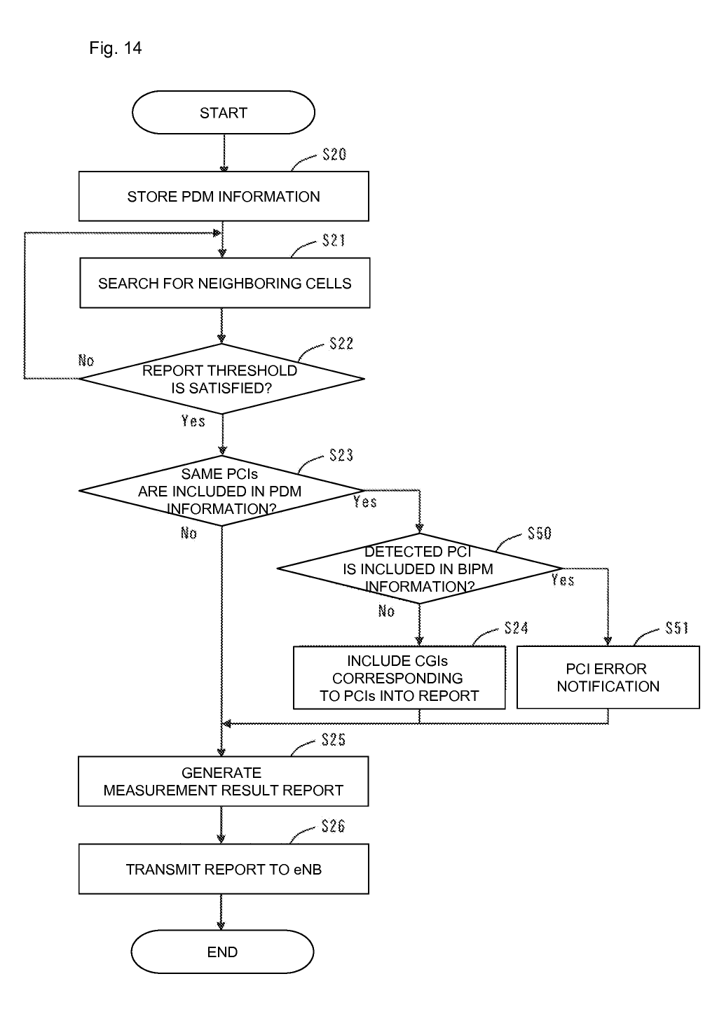

Next, operations of the mobile terminal 10 where a handover is controlled in the mobile communication system in the second embodiment will be described with reference to a flow diagram of FIG. 14. Here, operations of the mobile terminal 10 in this embodiment will be described mainly with respect to what are different from the first embodiment.

If the PDM information includes an entry of a PCI detected by the mobile terminal 10, the mobile terminal 10 further checks whether any of other detected PCIs is included in the BIPM corresponding to the PCI entry in the PDM information (S50).

If any of the other detected PCIs is included in the BIPM, the mobile terminal 10 performs a PCI error notification procedure by, for example, including an error flag into the reception quality report message or by changing the ranking order of PCIs to be included into the report message (S51). This error notification procedure is for notifying the eNB 20 of the presence of an error in the report message. Therefore, if the eNB 20 receives the error notification, the eNB 20 requires further detailed information about the PCI in question, for example an explicit CGI report using a second reception quality report, before determining the handover of the mobile terminal 10.

If none of the other detected PCIs are included in the BIPM, the mobile terminal 10 can extract a CGI corresponding to the detected PCI from the PDM information and include the CGI into the report message along with the PCI.

As an alternative to the above-described use of the BIPM, the following is also possible. When a PCI of a certain CSG cell is detected, and if a PCI of an adjacent CSG cell for the detected PCI is included in the BIPM and therefore it is determined that the detected PCI is of a CSG cell inaccessible to the mobile terminal 10, the frequency of measuring the reception quality for the cell may be made lower than that for other cells.

In the reception quality measurement process (S21), the mobile terminal 10 may use the PDM information to prioritize PCIs included in the PDM information in measuring the reception quality.

With the above mobile communication system in the second embodiment, functional effects similar to those in the first embodiment are achieved.

In this embodiment, the PDM information further includes the blacklisted inter-PCI map (BIPM) information, which is a list of cells on which the mobile terminal 10 cannot camp. The mobile terminal 10 may use the PDM information to verify the blacklisted inter-PCI map (BIPM) information before transmitting the measurement result report. In this embodiment, the PDM information is generated through the ID cell deployment mapping approach and provided to the mobile terminal 10 (or the eNB 20 or the HeNB 30). The mobile terminal 10 (or the eNB 20 or the HeNB 30) can ensure that the positions of the reported cells are accurate (i.e., the positions of the cells are reliable) according to the PDM information. Thus, in an inbound handover to a cell selected by the network as a handover destination, the mobile terminal 10 no more experiences a service interruption nor the wait time during moving.

In the mobile communication system in this embodiment, the deployment map information generation means generates the physical cell ID deployment map information further including physical cell ID information about a small cell around a small cell which is identified by using the identification information about the small cell and to which the mobile device is not granted access. The terminal device is configured to include determination means for, if a plurality of small cells having the same identification information are disposed within the macrocell, determining whether or not access to a small cell identified by using the identification information about the small cell is granted according to the physical cell ID deployment map information.

With the above configuration, the host device generates the PCI deployment map information further including the blacklisted inter-PCI map information, and the terminal device uses the PCI deployment map information (the blacklisted inter-PCI map information included therein) to determine whether or not access to a small cell is granted. For example, for two small cells having the same PCI existing within a macrocell, if a PCI of a small cell around one of the two small cells is included in the blacklisted inter-PCI map information and a PCI of a small cell around the other one of the two small cells is not included in the blacklisted inter-PCI map information, it can be known that access to the one small cell is not granted and access to the other small cell is granted. In this manner, even if two or more small cells having the same PCI exist within a macrocell, the occurrence of a PCI collision can be prevented.

In this embodiment, the terminal device is configured to include error report means for, when the determination means determines that access to the small cell identified by using the identification information about the small cell is not granted, transmitting an error report for the determined small cell to the host device.

With the above configuration, when two or more small cells having the same PCI exist within a macrocell, an error report for a small cell for which it is determined that access is not granted is transmitted from the terminal device to the host device. This enables the system to recognize the occurrence of a PCI collision.

In this embodiment, the terminal device is configured to include report priority control means for, when the determination means determines that access to the small cell identified by using the identification information about the small cell is not granted, controlling to heighten priority in transmitting the measurement result report to the host device for a small cell which is around the determined small cell and which is included in the physical cell ID deployment map information.

With the above configuration, when two or more small cells having the same PCI exist within a macrocell and it is determined that access to one of the small cells is not granted, control is performed to heighten the priority in transmitting the measurement result report for a small cell around the one small cell and included in the PCI deployment map information (the blacklisted inter-PCI map information). Thus, even if a system upper limit (e.g., up to eight) is set for the number of small cells for which the measurement result report can be transmitted, the measurement result report for the small cell to be used for determining whether or not access to the one small cell is granted can be preferentially obtained. This enables more accurate determination as to whether or not access to the one small cell is granted.

In this embodiment, the terminal device is configured to include fingerprint verification means for, according to a determination result of the determination means, verifying fingerprint information including physical cell ID information about previously accessed small cells.

With the above configuration, the fingerprint information is verified according to the result of determining whether or not access to a small cell is granted by using the PCI deployment map information (the blacklisted inter-PCI map information). Thus, for example, if a small cell determined as “accessible” according to the fingerprint information is determined as “non-accessible” according to the determination result, the fingerprint information may be updated from the old content “accessible” to the new content “non-accessible.”

In this embodiment, the terminal device is configured to include measurement frequency control means for, when the determination means determines that access to the small cell identified by using the identification information about the small cell is not granted, controlling to lower the frequency of measuring the reception quality for the determined small cell.

With the above configuration, when two or more small cells having the same PCI exist within a macrocell, control is performed to lower the frequency of measuring the reception quality for a small cell for which it is determined that access is not granted. Thus, performing unnecessary signaling can be avoided, and unnecessarily dedicating resources can be prevented.

In this embodiment, other signaling mechanisms (e.g., NAS signaling) may be used as the way of transmitting the PDM information to the terminal.

In this embodiment, the PDM information may be used for service extensions other than described above (e.g., machine-to-machine type communication and local IP access). In such cases, the PDM information is used for determining whether the terminal in question should perform an operation, such as signaling transmission to a server or establishment of a particular PDN (Packet Data Network) connection. Also in such cases, the PDM information may include additional information other than described above.

Thus, the embodiments of the present invention have been described by way of illustration. The scope of the present invention is not limited to the described embodiments but may be changed or modified depending on purposes within the range set forth in the claims.

While currently conceivable preferred embodiments of the present invention have been described above, it is to be understood that various modifications are possible to the embodiments, and appended claims are intended to encompass all such modifications within the true spirit and scope of the present invention.

### INDUSTRIAL APPLICABILITY

Thus, the mobile communication systems according to the present invention have advantages of the ability to avoid a service interruption caused by performing handover control to an inaccessible small cell, and the ability to reduce the wait time for handover control. Therefore the mobile communication systems are useful as, e.g., systems for controlling inbound handovers.

### REFERENCE SIGNS LIST

1 mobility management entity (MME)
2 mobility management unit
3 HeNB management unit
4 CSG list management unit
5 local PCI map management unit
6 PCI deployment mapping unit
10 mobile terminal (MT)
11 PDM control unit
12 measurement control unit
13 report control unit
14 PDM information storage unit
15 determination unit
16 fingerprint verification unit
17 measurement frequency control unit
18 error report unit
19 report priority control unit
20 macrocell base station (eNB)
21 mobility control unit
22 PDM information management unit
23 PDM information storage unit
24 determination unit
30 home base station (HeNB)
31 mobility control unit
32 PDM information management unit
33 PDM information storage unit
34 determination unit

1. A mobile communication system in which a handover of a terminal device from a macrocell base station to a small cell base station is controlled via a host device, wherein
the host device comprises:
cell position information reception means for receiving cell position information including identification information about small cells around the terminal device from the macrocell base station or a small cell base station on which the terminal device is camping;
small cell identification means for, according to the received cell position information, identifying small cells which are around the terminal device and to which the terminal device is granted access, by using the identification information about the small cells;
local map information acquisition means for acquiring local map information from small cell base stations for the identified small cells, the local map information including physical cell IDs of the identified small cells and physical cell IDs of small cells around the identified small cells; and
deployment map information generation means for, according to the acquired local map information, generating physical cell ID deployment map information including at least information indicating correspondences between the physical cell IDs and unique cell IDs of the small cells for which access is granted, and
the terminal device comprises:
deployment map information reception means for receiving the physical cell ID deployment map information generated by the host device from the host device; and
measurement result report generation means for generating a measurement result report of reception quality by using the physical cell ID deployment map information when a request to measure the reception quality for small cells around the terminal device for controlling a handover to any of the small cells is received via the host device.

2. The mobile communication system according to claim 1, wherein
the deployment map information generation means is for generating the physical cell ID deployment map information further including physical cell ID information about a small cell around a small cell which is identified by using the identification information about the small cell and to which the terminal device is not granted access, and
the terminal device comprises determination means for, if a plurality of small cells having the same identification information are disposed within the macrocell, determining whether or not access to a small cell identified by using the identification information about the small cell is granted according to the physical cell ID deployment map information.

3. A terminal device in which a handover from a macrocell to a small cell is controlled by a host device, wherein
in the host device, according to cell position information including identification information about small cells around the terminal device, small cells which are around the terminal device and to which the terminal device is granted access are identified by using the identification information about the small cells, and physical cell ID deployment map information including at least information indicating correspondences between physical cell IDs and unique cell IDs of the small cells for which access is granted is generated according to local map information including the physical cell IDs of the identified small cells and physical cell IDs of small cells around the identified small cells, and
the terminal device comprises:
deployment map information reception means for receiving the physical cell ID deployment map information generated by the host device from the host device; and
measurement result report generation means for generating a measurement result report of reception quality by using the physical cell ID deployment map information when a request to measure the reception quality for small cells around the terminal device for controlling a handover to any of the small cells is received via the host device.

4. The terminal device according to claim 3, wherein
in the host device, the physical cell ID deployment map information further including physical cell ID information about a small cell around a small cell which is identified by using the identification information about the small cell and to which the terminal device is not granted access is generated, and
the terminal device comprises
determination means for, if a plurality of small cells having the same identification information are disposed within the macrocell, determining whether or not access to a small cell identified by using the identification information about the small cell is granted according to the physical cell ID deployment map information.

5. The terminal device according to claim 4, comprising error report means for, when the determination means determines, that access to the small cell identified by using the identification information about the small cell is not granted, transmitting an error report for the determined small cell to the host device.

6. The terminal device according to claim 4, comprising report priority control means for, when the determination means determines that access to the small cell identified by using the identification information about the small cell is not granted, controlling to heighten priority in transmitting the measurement result report to the host device for a small cell which is around the determined small cell and which is included in the physical cell ID deployment map information.

7. The terminal device according to claim 4, comprising fingerprint verification means for, according to a determination result of the determination means, verifying fingerprint information including physical cell ID information about previously accessed small cells.

8. The terminal device according to claim 4, comprising measurement frequency control means for, when the determination means determines that access to the small cell identified by using the identification information about the small cell is not granted, controlling to lower the frequency of measuring the reception quality for the determined small cell.

9. The terminal device according to claim 3, comprising deployment map information storage means for storing the physical cell ID deployment map information received from the host device.

10. A base station device for a macrocell base station included in a mobile communication system in which a handover of a terminal device from a macrocell base station to a small cell base station is controlled via a host device, wherein
in the host device, according to cell position information including identification information about small cells around the terminal device, small cells which are around the terminal device and to which the terminal device is granted access are identified by using the identification information about the small cells, and physical cell ID deployment map information is generated according to local map information including physical cell IDs of the identified small cells and physical cell IDs of small cells around the identified small cells, the physical cell ID deployment map information including information indicating correspondences between the physical cell IDs and unique cell IDs of the small cells for which access is granted and physical cell ID information about a small cell around a small cell which is identified by using the identification information about the small cell and to which the terminal device is not granted access,
in the terminal device, reception quality for small cells around the terminal device is measured for controlling a handover to any of the small cells, and a measurement result report of the reception quality is transmitted to the macrocell base station, and
the base station device comprises:
deployment map information reception means for receiving the physical cell ID deployment map information generated by the host device from the host device; and
determination means for, if a plurality of small cells having the same identification information are disposed within the macrocell, determining whether or not access to a small cell included in the measurement result report received from the terminal device is granted according to the physical cell ID deployment map information.

11. A base station device for a small cell base station included in a mobile communication system in which a handover of a terminal device from a small cell base station to a small cell base station within a macrocell is controlled via a host device, wherein
in the host device, according to cell position information including identification information about small cells around the terminal device, small cells which are around the terminal device and to which the terminal device is granted access are identified by using the identification information about the small cells, and physical cell ID deployment map information is generated according to local map information including physical cell IDs of the identified small cells and physical cell IDs of small cells around the identified small cells, the physical cell ID deployment map information including information indicating correspondences between the physical cell IDs and unique cell IDs of the small cells for which access is granted and physical cell ID information about a small cell around a small cell which is identified by using the identification information about the small cell and to which the terminal device is not granted access,
in the terminal device, reception quality for small cells around the terminal device is measured for controlling a handover to any of the small cells, and a measurement result report of the reception quality is transmitted to a small cell base station on which the terminal device is camping, and
the base station device comprises:
deployment map information reception means for receiving the physical cell ID deployment map information generated by the host device from the host device; and
determination means for, if a plurality of small cells having the same identification information are disposed within the macrocell, determining whether or not access to a small cell included in the measurement result report received from the terminal device is granted according to the physical cell ID deployment map information.
